(19) United States
(12) Patent Application Publication
(10) Pub. No.: US 2015/0026718 A1
(43) Pub. Date: Jan. 22, 2015

(54) SYSTEMS AND METHODS FOR DISPLAYING A SELECTABLE ADVERTISEMENT WHEN VIDEO HAS A BACKGROUND ADVERTISEMENT

(71) Applicant: United Video Properties, Inc., Santa Clara, CA (US)

(72) Inventor: Douglas Seyller, Lisle, IL (US)

(73) Assignee: United Video Properties, Inc., Santa Clara, CA (US)

(21) Appl. No.: 13/946,285

(22) Filed: Jul. 19, 2013

(51) Int. Cl. H04N 21/44; H04N 21/854; H04N 21/81; H04N 21/4722; H04N 21/431

(52) U.S. Cl. CPC H04N 21/44008; H04N 21/4722; H04N 21/4316; H04N 21/812; H04N 21/854
USPC 725/34

(57) ABSTRACT

Systems and methods for displaying a selectable advertisement when a received video signal includes a background advertisement are discussed herein. In one embodiment, a video signal is received. This video signal may, for example, be a live broadcast of a sporting event such as baseball. The received video signal is then analyzed to determine whether it includes a background advertisement. A background advertisement might be an advertisement located at the baseball stadium that is visible in the live broadcast. If a background advertisement is detected, interactive features associated with the background advertisement may be identified and used to generate a selectable advertisement. In response to a user selection of the selectable advertisement, a function may be performed to trigger the interactive feature. For example, if the background advertisement is for media content available for purchase, the interactive feature may consist of purchasing and downloading the advertised content.

### BACKGROUND

Advertisers often purchase the right to place advertisements in locations known to be frequented by a large number of people, such as on billboards alongside busy freeways or at popular events. Moreover, advertisements may be captured in the background of a video or a static image and, once the video or image reaches the general public, such advertisements may also reach individuals that are watching the video or looking at the image at home. For example, in the case of sporting events, an advertisement's total audience might include both the people that are physically present at the stadium and those that are watching the sporting event at home on their television or other media device.

### SUMMARY

In view of the foregoing, systems and methods for displaying a selectable advertisement when a received video signal includes a background advertisement are provided.

In one embodiment, a video signal is received. This video signal may, for example, be a live broadcast of a sporting event such as baseball. The received video signal is then analyzed to determine whether it includes a background advertisement. A background advertisement might be an advertisement located at the baseball stadium that is visible in the live broadcast. If a background advertisement is detected, interactive features associated with the background advertisement may be identified and used to generate a selectable advertisement. In response to a user selection of the selectable advertisement, a function may be performed to trigger the interactive feature. For example, if the background advertisement is for media content available for purchase, the interactive feature may consist of purchasing and downloading the advertised content.

In one embodiment, an area of interest is identified within the received video signal, and image analysis is performed on this area. The area of interest may be identified based on information indicating the area of interest's location relative to a certain feature of the video signal. If this feature is detected in the received video signal, its location and the received information may be used to calculate the location of the area of interest. For example, if the video signal is a live broadcast of a sporting event, the feature might be line markings of a field associated with the sporting event.

In one embodiment, displaying the selectable advertisement may involve identifying where within a display of the video signal the background advertisement is located, and displaying the selectable advertisement at that location. Periodically a change vector may be calculated which reflects how much the video signal has changed between a previous image and the current image of the video signal. If the change in the video signal is below a threshold, the location of the displayed selectable advertisement may be updated based on its previous location and the calculated change vector.

In one embodiment, when it is determined that the video signal includes a background advertisement, information describing a first image of the video signal at that time may be stored. Additionally, the selectable advertisement may be stored and associated with the first image. At a later time, the first image can be compared with a new current image of the video signal. If the two images match, the stored selectable advertisement may be retrieved and displayed.

In one embodiment, optical character recognition is performed on the current image of the video signal. The resultant text is used to generate a search string and to search a database of media guidance data to identify media content matching the search string. When an interactive function associated with the background advertisement is then triggered, the interactive function may include receiving the identified media content.

In one embodiment, the image analysis performed to identify the background advertisement identifies a sponsor of the background advertisement. A request can then be transmitted to a server associated with the sponsor, and, in response, information identifying interactive features associated with the background advertisement may be received. This received information may then be used to generate the selectable advertisement. An image that is displayed as part of the selectable advertisement may also be received from the sponsor's server.

It should be noted that the systems and/or methods described above may be applied to or used in combination with other systems and/or methods as described below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments;

FIG. 3 shows an illustrative user equipment device in accordance with some embodiments;

FIG. 4 is a diagram of an illustrative cross-platform interactive media system in accordance with some embodiments;

FIG. 5 shows an illustrative sporting event together with the position of camera used to record the sporting event that may generate a video signal with background advertisements in accordance with some embodiments;

FIG. 6 shows an illustrative advertisement in accordance with some embodiments;

FIG. 7 shows an illustrative display screen that may be displayed at a user equipment device in accordance with some embodiments;

FIGS. 8A and 8B show illustrative display screens that may include a selectable advertisement overlaid onto a background advertisement that may be highlighted and enlarged in response to user input in accordance with some embodiments;

FIG. 9 shows an illustrative display screen that may include a selectable advertisement presented in a separate area of the display screen in accordance with some embodiments;

FIG. 10 shows an illustrative display screen that may include a selectable advertisement overlaid onto a background advertisement in accordance with some embodiments;

FIG. 11 is a flow chart of a process for displaying a selectable advertisement if a received video signal includes a background advertisement in accordance with some embodiments;

FIG. 12 shows an illustrative sporting event together with advertisement locations and camera positions in accordance with some embodiments;

FIG. 13 is a flow chart of a process for performing image analysis to identify background advertisements and to display selectable advertisements in accordance with some embodiments;

FIG. 14 is a flow chart of a process for using multiple areas of interest to identify background advertisements in accordance with some embodiments; and

FIG. 15 is a flow chart of a process for generating a selectable advertisement with interactive features for display in accordance with some embodiments.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

Some types of content may include a video signal. A video signal may include all information involved in generating a video for display, but accompanying metadata that is not used to display the video might not be considered part of the video signal. An on-demand program may therefore include a video signal (e.g., data that conveys the actual images to be generated for display), but not all data received as part of the on-demand program might be considered part of the video signal (e.g., synchronous metadata that describes individual scenes in the program). For example, metadata defining the aspect ratio of the video, an appropriate brightness, or other features of a video to be displayed may be considered part of the video signal, while other metadata, such as the media guidance data described below, might not be considered part of the video signal.

Additionally, while a video signal may be described as a series of images, the video signal need not be encoded or processed in this manner. For example, even though a series of images are eventually displayed, all processing of the video signal leading up to the display may be performed on a compressed version of the video signal that has either its time and/or dimensional information converted into the frequency domain. However, such a compressed video signal may still be described as consisting of a series of images. Similarly, while processing or analyzing the compressed video signal may not involve processing or analyzing the images that may be eventually displayed to the user, such processing or analysis may still be considered image processing or analysis.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

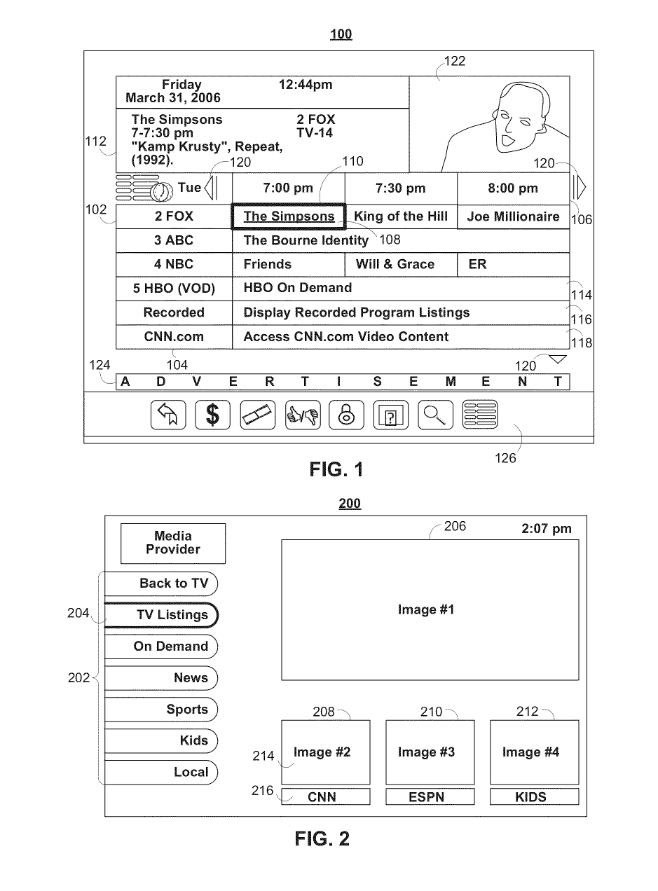

FIGS. 1-2, 6, and 8A-10 show illustrative display screens that may be used to provide media guidance data. The display screens shown in FIGS. 1-2, 6, and 8A-10 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. As referred to herein, triggering an interactive feature means executing a function. For example, triggering a function associated with advertisement 124 may involve executing any of the functions discussed above in response to a user selection of advertisement 124. Advertisement 124 may be targeted based on a user profile/preferences, monitored user activity, the type of display provided, or on other suitable targeted advertisement bases. The function executed in response to a user selection of advertisement 124 may also be impacted by the user profile/preferences. For example, the user profile/preferences may include login information for one or more social networking services. In this example, in response to a user selection of advertisement 124, the login information is retrieved and a function is performed in connection with the social networking service identified in the user profile/preferences. Such a function may include updating an online profile to indicate a preference for a program or product associated with advertisement 124, transmitting a message to other members of the user's social network, generating an online post related to advertisement 124 and/or otherwise impacting the user's online presence.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display.

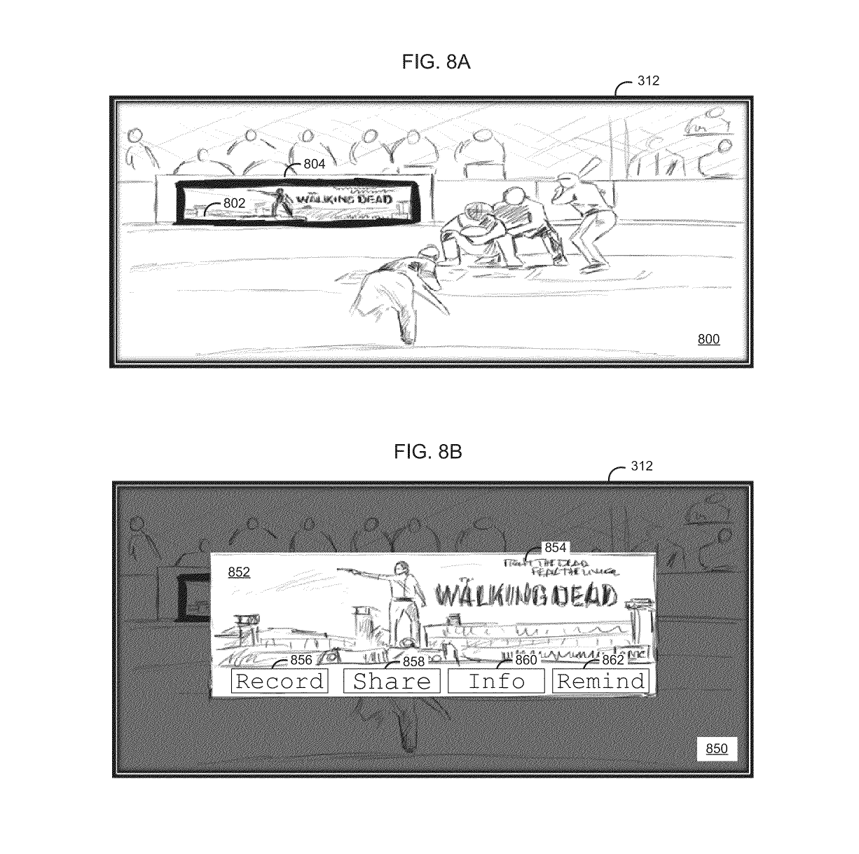

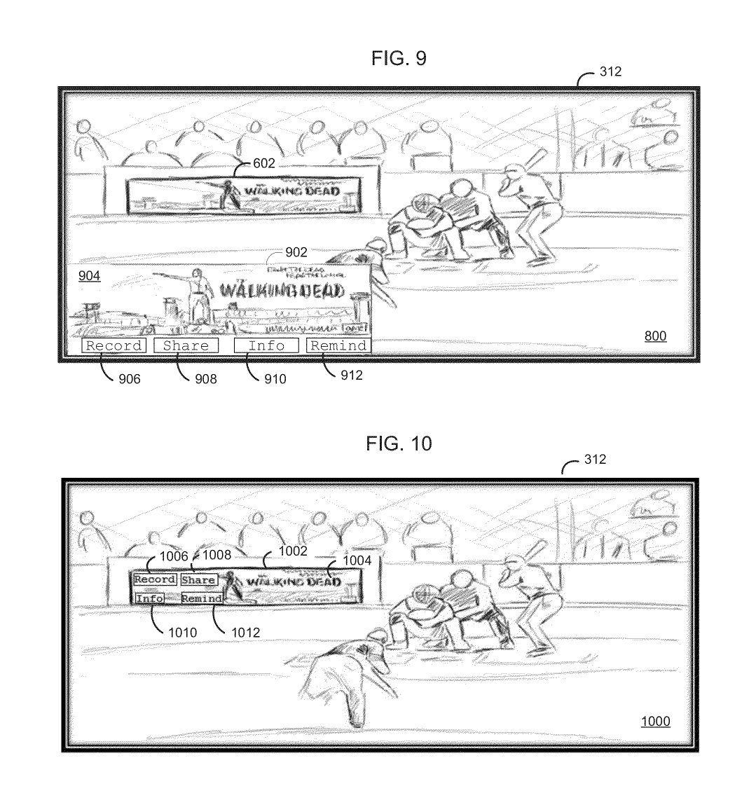

Advertisements may also be displayed over or alongside content with none or only a subset of the user interface elements present in display 100 (e.g., selectable advertisement 802 of FIG. 8, selectable advertisement 904 of FIG. 9 and selectable advertisement 1002 of FIG. 10). Timing and location of when and where such an advertisement is displayed may be dynamically determined by the media guidance application and may be based on a particular segment of the content being displayed. For example, the media guidance application may cause the advertisement to be displayed only if the video signal meets certain criteria or only if certain elements are present in the current image of the video signal. Similarly, the media guidance application may cause the advertisement to be displayed at a particular location of the display based on an element present at that location within the current image of the video signal (e.g., advertisement 802 of FIG. 8 and selectable advertisement 1002 of FIG. 10).

While advertisement 124 of FIG. 1, selectable advertisement 802 of FIG. 8, selectable advertisement 904 of FIG. 9 and selectable advertisement 1002 of FIG. 10 are discussed as being generated by the media guidance application, this need not be the case. These advertisements may also be generated by separate software (e.g., a third party application) and/or by separate hardware (e.g., a processor different from the processor executing the media guidance application and/or dedicated digital circuitry). This separate software and/or hardware may be located at any one of media content source 416, media guidance data source 418, user equipment 300 and/or a third party server. Additionally, this separate software and/or hardware may utilize any of the techniques discussed in reference to the media guidance application. For example, the third party application may be implemented partially as a client application on control circuitry 304 of user equipment device 300 and partially on media guidance data source 418 as a server application running on control circuitry of the remote server.

Advertisements may also include text, images, rotating images, video clips, or other types of content described above. While advertisement 124 is illustrated as a single element within display 100, an advertisement may include multiple distinct regions or elements. For example, a first area of an advertisement may include an image, while other elements of an advertisement may include selectable options that are each associated with a different interactive feature. In this example, receiving a user selection of the image does not trigger any interactive feature, while a user selection of one of the selectable options may trigger a different interactive feature associated with each selectable option.

Advertisements may be stored in a user equipment device having a guidance application, in a database connected to the user equipment, in a remote location (including streaming media servers), or on other storage means, or a combination of these locations.

Advertisements, such as advertisement 124 of FIG. 1, selectable advertisement 802 of FIG. 8, selectable advertisement 904 of FIG. 9 and selectable advertisement 1002 of FIG. 10, which have interactive features associated with them, may be considered selectable advertisements. As referred to herein, a selectable advertisement means an advertisement that has an interactive feature associated with it. Such advertisements might not be entirely contained within the video signal, but can be subsequently overlaid onto, embedded into, or transmitted with the video signal. Additionally, a selectable advertisements may include information that is not part of the video signal and that is used to trigger an associated interactive feature. In contrast, as referred to herein, a background advertisement means a non-interactive advertisement that is entirely part of the video signal as received from a transmission source (e.g., media content source 416). Even if an advertisement is the focus of the video signal (e.g., the video signal is a commercial for a product and/or the video signal is a documentary on the advertisement and includes a full-screen view of the advertisement), such an advertisement may be considered a background advertisement. Additionally, if the content also includes data that facilitates the provision of interactive features (e.g., the content includes synchronous metadata that triggers the display of selectable options on some user devices), the portion of the advertisement that is non-interactive and is entirely in the video signal (e.g., images of the advertisement within the video signal) may be still considered a background advertisement.

A background advertisement may become a selectable advertisement by the display of a separate selectable advertisement associated with it, by the display of selectable options associated with it, or even without the display of any additional information. For example, a background advertisement may be considered part of a selectable advertisement if a check is performed to determine if the user has selected the background advertisement (e.g., by determining if a user has selected an area of the display associated with the background advertisement) and, in response, an interactive feature associated with the background advertisement is triggered. This would be the case whether or not any additional information associated with the background advertisement is displayed in order to convert it into a selectable advertisement. A selectable advertisement that is transmitted to another device may still be considered a selectable advertisement, even if some information associated with it is received by the other device as part of the video signal. Continuing with the example noted above, if a video signal is received alongside information identifying areas of the display that include a background advertisement and that, if selected by a user, trigger an interactive feature, the result may be considered a selectable advertisement.

Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. One or more of these interactive features may also be associated with advertisement 124. For example, if advertisement 124 is for a program, any one of these interactive features may be triggered in response to a user selection of advertisement 124. As another example, advertisement 124 may include multiple selectable options that each triggers one of these interactive features. Options available from a main menu display may include search options, VOD options, parental control options, Internet options, cloud-based options, device synchronization options, second screen device options, options to access various types of media guidance data displays, options to subscribe to a premium service, options to edit a user profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

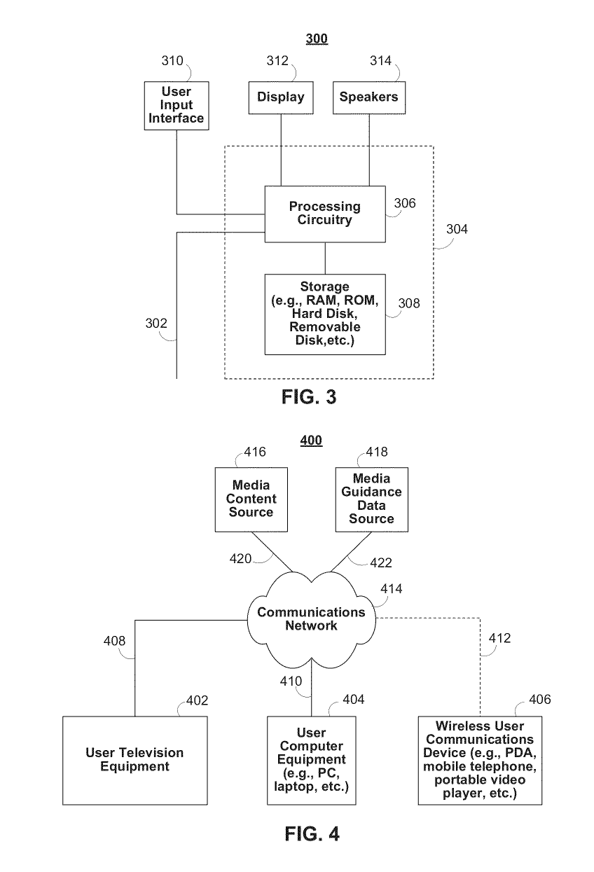

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Processing circuitry 306 may also include one or more multi-threaded processors, with the multiple threads interacting in a similar manner as the multiple separate processors. Accordingly, processing discussed as being performed by multiple separate processors below may also be performed by different threads of a single processor. In some implementations involving multiple processors and/or multi-threaded processors, the multiple processors and/or threads of a single processor may exchange processing results and other data using tightly coupled memory (e.g., a part of storage 308). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content, including any video signal that is part of the content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, and wireless user communications device 406) may be referred to as a “second screen device.” For example, a second screen device may supplement content presented on a first user equipment device. The content presented on the second screen device may be any suitable content that supplements the content presented on the first device. For example, any of the selectable advertisements discussed below may also be displayed on the second screen device, while the background advertisement is displayed on the first device. As another example, the selectable advertisement may be displayed on the first device, while the interactive feature associated with the selectable advertisement is presented on the second screen device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

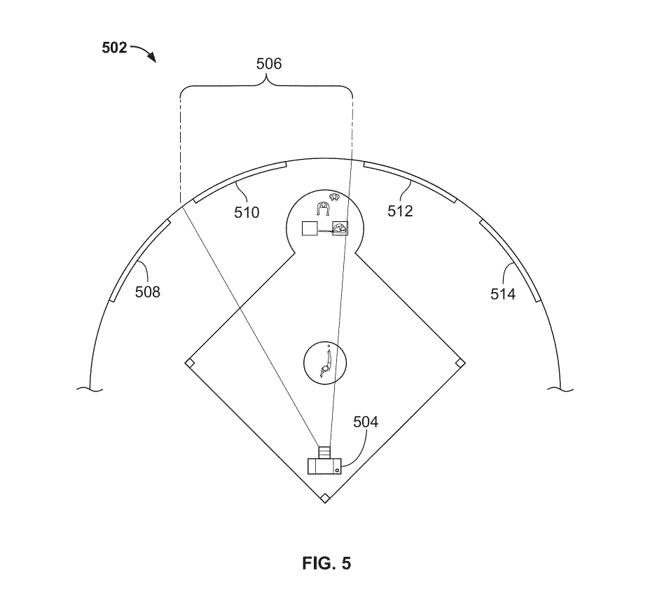

Generating content can involve capturing events occurring at a physical location. For example, a video signal can be generated by recording an event with a video camera. Other devices (e.g., a microphone) may be used to generate other types of media content (e.g., an audio signal). FIG. 5 illustrates sporting event 502 which is being recorded by camera 502. This particular sporting event is illustrated as a baseball game. Camera 502 generates a video signal which includes field of view 504. The physical location of sporting event 502 includes advertisements 506 through 512.

An advertisement present at the physical location may also be captured by camera 502 if it is within field of view 504. Here, advertisement 508 is within field of view 504 and may thus be visible in the video signal generated by camera 502, whereas advertisements 506, 510 and 512 are outside of field of view 504 and might thus not be visible in the generated video signal. The parts of advertisement 508 visible in the generated video signal may be considered a background advertisement. Once the video signal is generated, it may be transmitted or transported to media content source 416 for subsequent transmittal to user equipment device 300.

While FIG. 5 illustrates the generation of a video signal that includes a background advertisement through the recording of events at a physical location, video signals may also be generated in other manners. For example, a video signal may be entirely animated with the aid of computers. However, even such animated video signals may include background advertisements, and the methods and systems discussed in this application are equally applicable to such animated video signals.

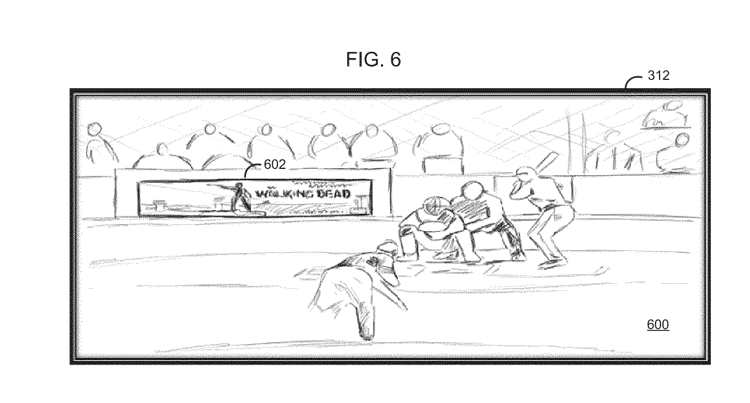

FIG. 6 illustrates display 312 of user equipment device 300 as it displays screen 600. Screen 600 is an image of the video signal generated by camera 502 and reflects field of view 504. Advertisement 508, after being captured by camera 502, is displayed in screen 600 as background advertisement 602. Background advertisement 602 might not be interactive and thus might not be associated with any interactive features.

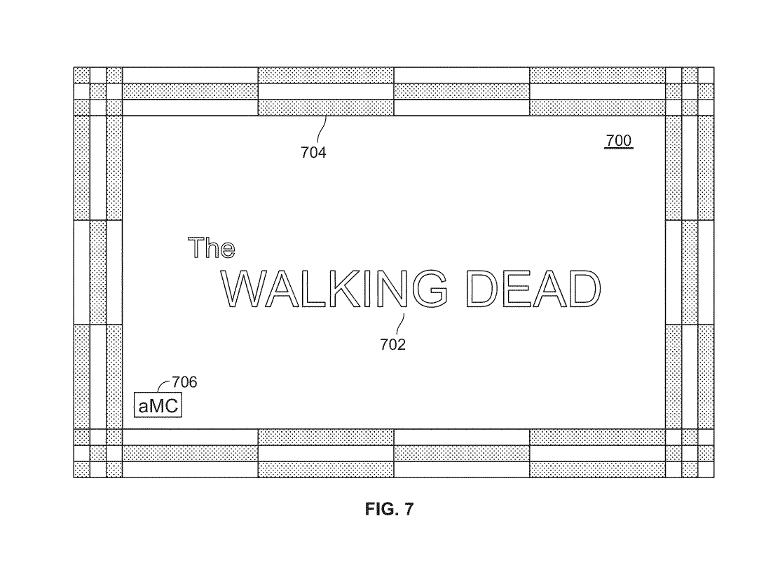

FIG. 7 illustrates advertisement 700, which may correspond to advertisement 508 and thus be presented in a video signal as background advertisement 602. Advertisement 700 may advertise subject matter 702 and include a logo for sponsor 706. Additionally, advertisement 700 may include border 704 or other characteristics that indicates that this is an advertisement, indicates subject matter 702 and/or indicates sponsor 706.

Subject matter 702 of advertisement 700 can be a program, product, service, company or any other entity, object or concept being advertised. For example, if subject matter 702 is a company, advertisement 700 might include only a logo associated with the company.

Sponsor 706 might be a provider of subject matter 702 (e.g., media content source 416, a source of an advertised program, a producer or seller of an advertised product, a provider of an advertised service), a provider of advertisement 700 (e.g., a company that designed advertisement 700) or an owner of the location of the advertisement (e.g., if the advertisement is a billboard in a stadium, the owner might be the owner of the stadium, the sports team playing at the stadium, or a licensee of the advertisement space that then leases the advertisement space to other entities).

Subject matter 702 and sponsor 706 may be advertised within advertisement 700 using text, images or even video. Additionally, there need not be a distinction between the subject matter and sponsor of an advertisement. For example, an advertisement may advertise the sponsor, in which case the subject matter and sponsor of the advertisement would be the same.

Additionally, advertisement 700 may include characteristics that may facilitate identification of the advertisement. For example, border 704 may indicate that an advertisement is present (without specifying any further information), indicate the sponsor of the advertisement, indicate the location of the advertisement, or indicate the subject matter of the advertisement. This indication may be accomplished by having border 704 include text, images or a pattern that the media guidance application is able to interpret when processing a received video signal. For example, different patterns may each be associated with a different sponsor and/or subject matter.

FIG. 8A illustrates screen 800 as it is displayed on display 312. Similar to screen 600, screen 800 also reflects field of view 504. However, screen 800 includes selectable advertisement 802. This may be reflected by the fact that selectable advertisement 802 is surrounded by border 804, which indicates to the user that an interactive feature is associated with selectable advertisement 802. Alternatively, border 804 may not be displayed or may be displayed in a different color or style until a user selection of selectable advertisement 802 is received. In response to a user selection of selectable advertisement 802, the media guidance application may cause border 804 to be displayed or visually altered in order to indicate that selectable advertisement 802 has been highlighted.

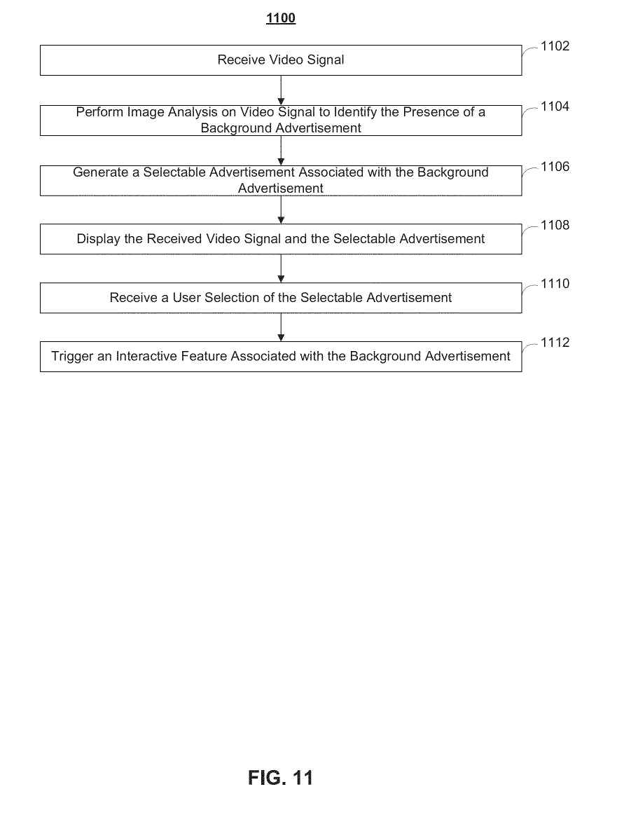

The video signal that includes view 504 may have been received without a selectable advertisement (e.g., only background advertisement 602 may have been received), and selectable advertisement 802 may have been generated local to user equipment device 300. For example, the media guidance application may have executed process 1100 of FIG. 11 to generate selectable advertisement 802.

While selectable advertisement 802 is illustrated as visually replacing background advertisement 602, selectable advertisement 802 may be displayed or otherwise becomes available using a number of different approaches. In particular, generating or displaying a selectable advertisement does not require that a background advertisement be replaced and/or no longer displayed and/or that additional selectable objects besides the received video signal be displayed. Instead, generating and displaying a selectable advertisement may only require that an advertisement (e.g., a received background advertisement and/or a locally generated advertisement) be displayed and that an interactive feature associated with the displayed advertisement be available. For example, background advertisement 802 may be displayed as received, but the media guidance application may associate interactive features with background advertisement 602 (e.g., by causing certain user inputs to trigger interactive features if received while background advertisement 602 is displayed), thereby converting it into selectable advertisement 802. Such a conversion of background advertisement 602 into selectable advertisement 802 may still be described as entailing the generation and display of a selectable advertisement. The media guidance application may also cause selectable advertisement 802 to be displayed as an overlay over background advertisement 602 and/or at another location within screen 800. Background advertisement 602 may continue to be displayed to identify the subject matter of the advertisement (e.g., a product, program, service or company being advertised), but the media guidance application may cause selectable options to be displayed in order to associate background advertisement 602 with interactive features. Additionally, the image of the video signal may be modified to replace background advertisement 602 with an alternative advertisement image.

Selectable advertisement 802 is illustrated as having the same subject matter as background advertisement 602. However, this need not be the case. For example, background advertisement 602 may advertise a sponsor, while selectable advertisement 802 advertises a program, product or service available from the sponsor. This may be used in connection with the user profile to allow selectable advertisement 802 to be targeted. For example, the media guidance application may determine that background advertisement 602 is for media content source 416 and, based on the user profile and/or by requesting information from media content source 416, generate a selectable advertisement for a program that matches user preferences stored in the user profile. Moreover, background advertisement 602 may only advertise the advertisement's sponsor, and the media guidance application may then request a selectable advertisement to be displayed from a server associated with the advertisement's sponsor. In fact, the media guidance application may just determine that a particular location within screen 800 is suitable for a selectable advertisement (e.g., because there is a background advertisement or an empty advertisement space present in that location) and generate a selectable advertisement for display completely independent of any background advertisement.

In response to a user selection of selectable advertisement 802, the media guidance application may cause selectable options for interactive features associated with selectable advertisement 802 to be displayed. As illustrated in FIG. 8B, the media guidance application may cause overlay 852 to be displayed in screen 850. Overlay 852 includes information 854 identifying the subject matter of selectable advertisement 802 and selectable options 856-862.

In response to a user selection of any one of selectable options 856-862, the media guidance application may execute a function to trigger the interactive feature associated with the selectable option. Additionally, causing overlay 852 to be displayed in response to a user selection of selectable advertisement 802 may itself be considered an interactive feature. In this example, as identified by information 854, selectable advertisement 852 is for a program. As such, overlay 852 may be generated based on media guidance data associated with the program. This may include identifying interactive features available for the program, such as record option 856, share option 858, additional information option 860 and remind option 862. Alternatively, identifying interactive features that are associated with selectable advertisement 802 may involve retrieving information from another source of data, such as data received together with the video signal from media content source 416 and used to generate screen 800, additional information included in media guidance data for video signal displayed in screen 800, data retrieved from a remote database associated with a sponsor of background advertisement 602 (e.g., the owner of physical advertisement 508, the entity that paid for advertisement 508, or a provider of the subject matter of advertisement 508) and/or data retrieved from a local database of advertisement information. Additionally, information 854 may also be generated based on media guidance data received from media guidance data source 418, information retrieved from any of the other sources of data discussed above, or information and/or images extracted from the video signal (e.g., information 854 may be a copy of background advertisement 602).

The media guidance application may schedule a program identified by information 854 for recording in response to a user selection of option 856. This may involve scheduling a specific instance of the program (e.g., a time and channel on which the program will be broadcast) that is associated with selectable advertisement 802. Alternatively, selectable advertisement 802 may be associated with the program or an entire series, and not specific instances, in which case the media guidance application may search for and identify instances of the program (e.g., the next instance of the broadcast or instances of one or more episodes a series) for recording. The media guidance application may also search for and download copies of one or more programs associated with selectable advertisement 802 that are available on-demand from media content source 416.

The media guidance application may “share” a program identified by information 854 or otherwise interact with a user's online social network in response to a user selection of option 858. For example, the media guidance application may retrieve information identifying an online social network and/or the user's login information for an online social network from the user profile/preferences and utilize this information to log into an online user profile associated with the online social network. The media guidance application may then modify the user's online profile to include an indication of approval for the advertised program (e.g., add the program to a “favorites” list), post an indication of approval for the advertised program on the online social network, and/or transmit a message on behalf of the user to other members of the online social network regarding the advertised program. Alternatively, the media guidance application may modify the user profile maintained by the media guidance application (e.g., add the advertised program to a “favorites” list) or the media guidance application may directly update the online user profile (because, e.g., media guidance data source 418 also hosts the online social network, the media guidance application is customized based on the online user profile and/or the media guidance application maintains the online user profile).

The media guidance application may cause additional information regarding the program identified by information 854 to be displayed in response to a user selection of option 860. The additional information may be directly associated with selectable advertisement 802 (e.g., information retrieved as part of generating selectable advertisement 802), may consist of media guidance data for a program or series identified by information 854, may be received in response to a search for additional information based on the subject matter of background advertisement 602 (e.g., an Internet search that uses information 854 as a search string) and/or information received from a sponsor of background advertisement 602.

Similarly to scheduling a recording in response to a user selection of selectable option 856, the media guidance application may also set a reminder for an instance of a program, a program or a series of programs in response to a user selection of selectable option 862. Additionally, information 854 may be passive (i.e., the media guidance application does not perform any function in response to a user selection of information 854) or interactive (e.g., information 854 may be associated with any interactive feature described in this application).

The media guidance application may generate additional selectable options for any interactive features available for programs. While options 856-862 are discussed in relation to a program, selectable advertisement 802 may be for any product, service, provider or other subject matter. Interactive features associated with selectable advertisement 802 may be accordingly varied. For example, if selectable advertisement 802 is for a product, overlay 852 may include selectable options for ordering the product, subscribing to regular deliveries of the product, requesting additional information or a demonstration video of the product and/or reading online reviews of the product. Any appropriate interactive feature may be associated with any selectable advertisement. Additionally, while FIG. 8B discusses executing functions for performing interactive features in response to a user selection of selectable options 856-862 of overlay 852, any of these functions can also be automatically executed in response to a user selection of selectable advertisement 802.

FIG. 9 illustrates screen 900 as it is displayed on display 312. Similar to screens 600 and 800, screen 900 also reflects field of view 504. Screen 900 demonstrates an alternative configuration for displaying a selectable advertisement associated with background advertisement 602, in this case selectable advertisement 904. Similar to selectable advertisement 802 of FIG. 8, selectable advertisement 904 may have been generated locally by the media guidance application using process 1100 of FIG. 11. Selectable advertisement 904 includes selectable options 906-912 which may cause the same functions to be performed in response to a user selection as those executed in response to a user selection of options 856-862 of FIG. 8B, respectively. Selectable advertisement 904 may also include information 902 corresponding to information 854.

Unlike selectable advertisement 802, which was located within screen 800 at the location of background advertisement 602, selectable advertisement 904 is located at a different location within screen 900 than background advertisement 602. Selectable advertisement 902 may be an overlay that is displayed over the video signal or may be a separate region of screen 900 that is generally not used for the display of the video signal. As another alternative, the video signal may be reformatted to not include a region of screen 900 whenever it is determined that selectable advertisement 904 ought to be displayed, and selectable advertisement 904 may be displayed in this region. The video signal may also be modified by media content source 416 to include selectable advertisement 904.

Selectable advertisement 904 may be automatically displayed whenever the media guidance application determines that background advertisement 602 is present in screen 900, or selectable advertisement 904 may be displayed in response to a user selection of selectable advertisement 802 and/or background advertisement 602. Additionally, the media guidance application may cause overlay 852 to be displayed in response to a user selection of selectable advertisement 904 or any one of options 906-912 displayed therein.

While selectable advertisement 904 is illustrated as including information describing the subject matter of background advertisement 602 (e.g., information 902 may identify a product, program, service, sponsor or company), selectable advertisement may also consist of only one or more selectable options, such as one or more of options 906-912 (e.g., information 902 might not be displayed). For example, the media guidance application may display one or more selectable options anywhere in screen 900 and, in response to a user selection of one of these selectable options, perform a function associated with background advertisement 602. In fact, the media guidance application might not cause any selectable advertisement and/or selectable options to be displayed, but may instead (if anything at all) cause text directing a user to provide a certain input (e.g., “Press ENTER”) to be displayed. Accordingly, the method and systems described in this application are also applicable to determining when to perform functions in response to user input and/or which function to perform when a background advertisement is displayed, even if the media guidance application does not cause any selectable options to be displayed.

FIG. 10 illustrates screen 1000 as it is displayed on display 312. Similar to screens 600, 800 and 900, screen 1000 also reflects field of view 504. Screen 1000 demonstrates another alternative configuration for displaying a selectable advertisement associated with background advertisement 602, in this case selectable advertisement 1002. As with selectable advertisement 802 of FIG. 8 and selectable advertisement 904 of FIG. 9, selectable advertisement 1002 may have been generated locally by the media guidance application using process 1100 of FIG. 11. Selectable advertisement 1002 includes selectable options 1006-1012 which may cause the same functions to be performed in response to a user selection as those executed in response to a user selection of selectable options 856-862 of FIG. 8B, respectively. Selectable advertisement 1002 may also include information 1004 corresponding to information 854.

Selectable advertisement 1002 may replace background advertisement 602 by, for example, being overlaid onto the location of background advertisement 602. Alternatively, selectable advertisement 1002 may be generated by overlaying, or otherwise including, selectable options 1006-1012 onto background advertisement 602. In this alternative, background advertisement 602 is still visible in screen 1000, in which case information 1004 may actually be the visible portion of background advertisement 602. If that is the case, background advertisement 602 might be considered part of selectable advertisement 1002.

In order to generate any of the selectable advertisements and selectable options shown in FIGS. 8-10, the media guidance application may perform process 1100 of FIG. 11. One or more steps of process 1100 can be executed by processor circuitry 306 of user equipment device 300, processing circuitry of media content source 416 and/or processing circuitry of media guidance data source 418. For example, some or all of the steps of process 1100 may be performed by processing circuitry of media content source 416 and result in the transmission of metadata to user equipment device 300 that is then utilized by processing circuitry 306 to generate a selectable advertisement for display. Similarly, some or all of the steps of process 1100 may be performed by processing circuitry of media guidance data source 418 in order to leverage potentially greater computation power available at media guidance data source 418 than at user equipment device 300. In general, it is understand that any steps described as being performed by or at user equipment device 300, media content source 416, media guidance data source 418 and/or another remote source or remote server is performed processing circuitry 306, processing circuitry of media content source 416, processing circuitry of media guidance data source 416 and/or processing circuitry of the other remote source or remote server, respectively.

A video signal is received from media content source 416 at step 1102. The video signal may be received over input 302 and may be received separately from or together with associated metadata. The video signal may be part of any content discussed in this application. Additionally, process 1100 is equally applicable to individual images, and an individual image may be received at step 1102.

At step 1104, the media guidance application performs image analysis on the received video signal to determine if any background advertisements are present. Any analysis that involves analyzing the video signal can be considered image analysis. This might include processing that also partly relies on received metadata (e.g., determining the color of an area in one or more images of the video signal that requires comparing the received video signal with reference values found in the accompanying metadata, or identifying which area of the received video signal to analyze based on received metadata), but might not include processing that entirely relies upon analyzing the received metadata (e.g., retrieving tags received together with video signal and performing an action based on the these tags). Some general examples of image analysis include matching images of the received video signal against patterns stored in memory, analyzing a spectrogram of the received signal to identify certain traits, and correlating the video signal in time to identify static areas of the video signal. Specific image analysis techniques that may be applied to determine if any background advertisements are present in the video signal are discussed throughout this application.

The media guidance application may also identify the subject matter and/or sponsors of one or more background advertisements either at step 1104 or as a separate step. For example, performing image analysis on the received video signal may involve matching the received video signal against potential background advertisements. In that case, identifying the subject matter of a background advertisement may be performed as part of step 1104, since identifying that a potential background advertisement is in the video signal will also identify the subject matter and/or sponsor of the background advertisement. Images and patterns that can be used to both determine the presence of a background advertisement and to identify the subject matter or sponsor of the background advertisement can be referred to as advertisement-specific images and patterns.

In other cases, an additional step may be necessary after step 1104 in order to identify the subject matter and/or sponsor of a background advertisement. In these cases, the image analysis performed at step 1104 may only indicate that a background advertisement is present, while additional image analysis is necessary to identify the subject matter and/or sponsor. For example, the background advertisement may include a characteristic, such as border 704, that indicates the presence of a background advertisement but does not indicate the subject matter and/or sponsor. In this example, additional image analysis, such as optical character recognition (OCR), may be necessary to obtain this additional information. Images and patterns that can be used to detect the presence of a background advertisement but that do not identify the subject matter or sponsor of the background advertisement can be referred to as general images and patterns.

At step 1106, the media guidance application may generate a selectable advertisement that is associated with the background advertisement. If the previous steps identified the subject matter of the background advertisement for which the selectable advertisement is generated, the media guidance application may still need to retrieve, receive or otherwise identify interactive features that will be associated with the selectable advertisement. If the previous steps only identified a sponsor of the background advertisement, the media guidance application may additionally retrieve, receive or otherwise identify the subject matter as well. Alternatively, the subject matter of the selectable advertisement may be the sponsor itself. Finally, if the media guidance application determines that a background advertisement is present, but is unable or does not attempt to identify a subject matter and/or sponsor of the background advertisement, the media guidance application may still generate a selectable advertisement.

The media guidance application may also generate information or images to be displayed as part of the selectable advertisement (e.g., information 902 and/or information 1004). This may involve retrieving or receiving the information or an image together with information identifying interactive features to be associated with the selectable advertisement, retrieving the information or image from another source (e.g., if the advertisement is for a program, media guidance data from media guidance data source 418 may dictate the interactive features, while an appropriate image is received from media content source 416) or extracting an image from the received video signal (e.g., the background advertisement may be extracted from the video signal for use in the selectable advertisement).

As part of generating the selectable advertisement, the media guidance application may populate a data structure with information identifying the sponsor of the background advertisement, information identifying the subject matter of the background advertisement, information identifying the one or more interactive features associated with the selectable advertisement, links to and/or data representing the image or information to be included in the selectable advertisement, and/or information identifying the location and/or content of the background advertisement. These data structures may be stored in storage 308 for each detected background advertisement or for a limited number of previously detected background advertisements (e.g., the most recently detected background advertisements, all background advertisements detected since the user started watching the program represented by the received video signal, or all background advertisements detected in programs currently being broadcast or otherwise available). Then, every time a background advertisement is detected, the media guidance application may first compare the newly detected background advertisement against the data structures stored in storage 308 in order to determine whether a new selectable advertisement and/or data structure needs to be generated.

At step 1108, the media guidance application may cause the selectable advertisement generated at step 1306 to be displayed. This may involve displaying an overlay of the selectable advertisement (e.g., selectable advertisement 802), incorporating parts of the selectable advertisement (e.g., the image associated with the selectable advertisement) into the video signal, displaying the selectable advertisement in an area of the display screen that is separate from the area of the screen in which the video signal is displayed (e.g., selectable advertisement 904), and/or displaying selectable options associated with the background advertisement to convert it into a selectable advertisement (e.g., selectable advertisement 1002).

Depending on how the selectable advertisement is to displayed, the media guidance application may need to determine the location of the background advertisement within a display of the received video signal in order to cause the selectable advertisement to be properly displayed. For example, the media guidance application might need to know the location of background advertisement 602 within screen 600 in order to cause selectable advertisements 802 and 1002 to be displayed. This information may be obtained as part of step 1104 or may be separately calculated and/or updated. For example, if the media guidance application detects the background advertisement by analyzing images of the video signal for certain characteristics (a rapid change in color along a straight line that indicate the border of the background advertisement), specific images (e.g., a part of a current image of the video signal matches an image of a potential background advertisement) and/or text (e.g., an area that includes text matching a sponsor's name is determined to be a background advertisement), the location within the video signal that the characteristic, image of text is found may be considered the location of the background advertisement. Alternatively, this image analysis may be performed solely to determine the location of the background advertisement (e.g., because received metadata already indicates that a background advertisement is present).

In addition to location, the media guidance application may need to determine the size and/or outline of the background advertisement in order to properly cause the background advertisement to be overlaid by the selectable advertisement. The media guidance application may determine this information by analyzing the current image of the video signal for a pattern that indicates the outline of a background advertisement (e.g., border 704) and/or by analyzing the vicinity of the determined location of the background advertisement for certain characteristics. For example, the background advertisement may have a background color, in which case the media guidance application may determine that the area surrounding the location of the background advertisement that includes the background color forms part of the background advertisement. Similarly, the media guidance application may determine that a rapid change in color (especially if occurring along a straight line) surrounding the location of the background advertisement indicates the edge of the background advertisement.

At step 1110, the media guidance application receives a user selection of the displayed selectable advertisement. This may involve processing a signal received from user input interface 310. The media guidance application may receive user input to navigate a cursor to a displayed selectable advertisement or selectable option. In response to this user input, the media guidance application may cause the selectable advertisement or selectable option to be displayed as highlighted, such as by causing border 804 to be displayed around selectable advertisement 802. The media guidance application may at appropriate times associate coordinates defining an area within display 312 with a selectable advertisement or selectable option. If that is the case, the media guidance application may consider receipt of a user selection of this area during these times a user selection of the selectable advertisement or selectable option. This may be the case even when no selectable advertisement or selectable option is actually displayed.

Additionally or alternatively, certain signals from user input interface 310, if received during particular times, may be considered by the media guidance application to constitute a user selection of a selectable advertisement or selectable option. For example, the media guidance application may consider a signal indicating that a user pressed “ENTER,” if received while a prompt is displayed on display 312 that reads “Press ENTER to select advertisement,” to constitute a user selection of a selectable advertisement.

At step 1112, the media guidance application may trigger an interactive feature associated with the background advertisement by executing a function. This may involve retrieving a data structure associated with the selectable advertisement (e.g., the data structure described in connection with step 1106, above) in order to determine which function to execute. For example, one of the fields of the data structure may include a pointer to a particular function or a value to be used in a look-up table. Executing the function may further involve retrieving media guidance data associated with a program (e.g., a program advertised in the selectable advertisement), transmitting an indication to a remote server associated with a sponsor of the selectable advertisement (e.g., a request for further information, a request to retrieve a website, or merely an indication that the selectable advertisement has been selected), modifying an online user profile, and/or executing any function or triggering any interactive feature described in this application.

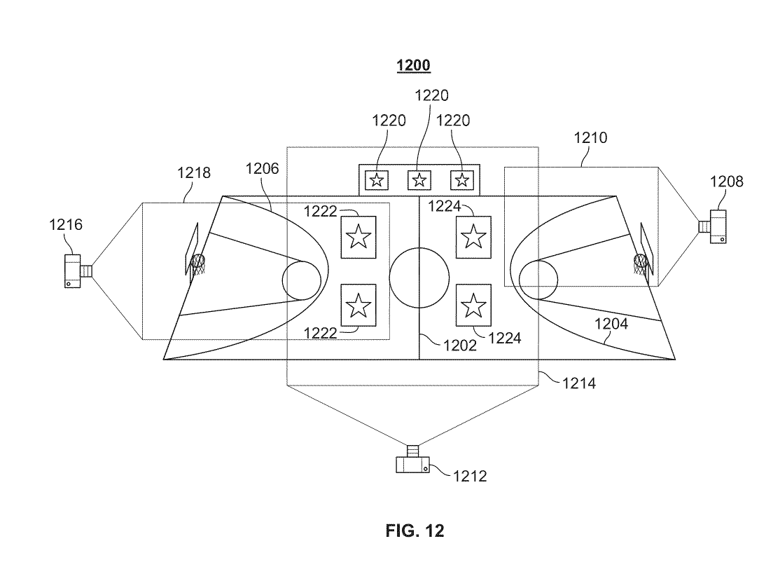

One particular set of types of events in which background advertisements may be found are sporting events. In this context, a particular type of event might be games of a particular sport. For example, baseball games might be considered a first type of event, while basketball games are a different second type of event. Each of these types of events may be associated with a particular playing field, such as field 1200 of FIG. 12. Field 1200 is illustrated as a basketball court and the associated type of event would be a basketball game. Field 1200 includes advertisement locations 1220-1224 and line markers 1202-1206. An event occurring at field 1200 may be recorded from multiple angles with cameras 1208, 1216 and 1212 capturing fields of view 1210, 1218 and 1214, respectively. Based on the images captured by cameras 1208, 1216 and 1212, one or more video signals can be generated for transmittal or transport to media content source 416. For example, the images captured by cameras 1208, 1216 and 1212 can be intertwined to generate a live broadcast of a basketball game. If any advertisements potentially present in advertisement locations 1220-1224 are recorded by a camera or otherwise become part of one or more video signals, they may be considered background advertisements.

The media guidance application may leverage known characteristics of the type of event presented by the video signal when detecting the presence of background advertisements and/or identifying the subject matter and/or sponsor of a background advertisement. For example, sporting events generally occur entirely within a particular field, such as field 1200. Even though the video signal may include different fields of views, such as fields of view 1218, 1212 and 1210, chances are that advertisement location 1220 will be visible in multiple images throughout the video signal. Therefore, once a background advertisement associated with advertisement location 1220 has been detected and/or identified, the media guidance application might be able to expect the same background advertisement or an alternative background advertisement (e.g., advertisement location 1220 may include rotating advertisements) to be found in the parts of the video signal corresponding to advertisement location 1220.

One type of advertisement location identifying information that may be leveraged is information identifying actual or potential advertisement locations within field 1200. Potential advertisement locations are also referred to as areas of interest. This advertisement location identifying information may indicate where within images of a video signal actual or potential advertisement locations may be. The locations may be indicated in reference to features of field 1200. For example, the advertisement location identifying information may indicate that advertisement locations 1220 are generally above or a particular scalable distance above line markings 1202. Alternatively, the advertisement location identifying information may indicate the location of actual or potential advertisements relative to all of field 1200 (e.g., advertisement locations 1220 is immediately above field 1200) or relative to cameras (e.g., advertisement locations 1220 is at a particular location within images generated by camera 1212 or by a camera located in a particular position and/or have a particular angle). Camera identification information (e.g., information identifying camera 1212), camera position and/or camera angle may all be determined based on characteristics of the received video signal (e.g., the location of line markings 1206, 1202 and 1204 within images of the video signal) or based on metadata received with the video signal (e.g., concurrently received metadata that indicates the camera generating each image of the video signal).

Another type of advertisement location identifying information is information that may help indicate the presence of a background advertisement. Such advertisement location identifying information may indicate that advertisement locations 1220 are surrounded by a particular color, are surrounded by or include a particular pattern, include one of a possible set of images, words and/or patterns, and/or other information that may be useful in identifying the advertisement. Alternatively or in combination, this type of advertisement location identifying information may include images of advertisements that are found or are likely to be found within the video signal (e.g., images of all advertisements surrounding field 1200).

Either type of advertisement location identifying information may be associated with the particular video signal (e.g., a specific basketball game) or with the type of event (e.g., all basketball games). Additionally, either type of advertisement location identifying information may be advertisement-specific or general. The advertisement location identifying information may be received from media content source 416 (e.g., the information may be received together with the video signal or may be separately retrieved by the media guidance application), received from media guidance data source 418 (e.g., as part of the software that makes up the media guidance application, as general media guidance data, or as media guidance data regarding the program represented by the video signal) and/or generated by the media guidance application (e.g., previously detected background advertisements are stored in a database of potential background advertisements, locations of previously detected background advertisements relative to features of field 1200 are stored as areas of interest, characteristics of the video signal when a background advertisement was detected can be compared with the current video signal to determine if the same background advertisement might be present).

If a video signal is generated using a single static camera, once a background advertisement is found, it would not change location within images of the video signal. However, camera 1212, which is capturing advertisement location 1220, may be mobile, and field of view 1214 may thus be constantly or occasionally changing. Advertisement location 1220 may thus not always be found in the same part of the video signal. However, the media guidance application may analyze a received video signal in order to determine changes in field of view 1214. For example, the media guidance application may correlate an earlier image or set of images with a later image or set of images in order to calculate a change vector for the video signal. The change vector may indicate the direction and/or magnitude of the change in field of view 1214. Calculating the change vector may involve correlating entire images of the video signal or only parts of image of the video signal. Alternatively, a change vector can be calculated by searching images of a video signal for a particular feature and calculating how the position of that feature has changed over time. For example, the media guidance application may identify the location of line markers 1202 within different images of the video signal at different points in time and use this information to calculate the change vector.

Another challenge is that the video signal may switch from field of view 1214 captured by camera 1212 to field of view 1218 captured by camera 1216 at any time. The media guidance application may need to determine this switch in field of view in order to discontinue using information regarding advertisement location 1220 assembled based on analysis of a video signal that includes field of view 1214, to switch to using information assembled based on analysis of a video signal that includes field of view 1218 and/or to begin assembling new information for view 1218. This change in camera can be identified based on metadata received with the video signal (e.g., metadata identifying the camera used to generate the video signal or metadata indicating a change in camera), by determining that a change vector has too large of a magnitude, and/or by failing to identify previously found line markings 1202 in a new image of the video signal.

A background advertisement may be present in more than one field of view. For example, advertisement locations 1222 are within field of view 1218 captured by camera 1216 and within field of view 1214 captured by camera 1212. The media guidance application may thus use information regarding advertisement locations 1222 (e.g., the presence or absence of background advertisements, the location within the video signal of these background advertisements, information identifying the subject matter and/or sponsor of these background advertisements, and/or selectable advertisements to be displayed if these background advertisements are visible) determined based on the video signal when it includes field of view 1214 or received when the received video signal includes field of view 1218. The media guidance application may determine that both fields of view include advertisement locations 1222 by determining that both include the same characteristics, such as the inclusion of line markers 1206 in both fields of view, or by analyzing received metadata describing the present field of view (e.g., camera location and angle information). In order to rely on advertisement location identifying information generated for or associated with another field of view, the media guidance application may need to account for change in perspective (e.g., an advertisement in advertisement locations 1222 would be turned by 90 degrees when captured by camera 1216 as opposed to camera 1212) or changes in scaling (e.g., field of view 1214 is larger than field of view 1218, so an advertisement or distance in an image captured by camera 1212 would appear smaller than the corresponding advertisement or distance appears in an image captured by camera 1216). Changes in perspective and scaling can be determined by correlating the images, by comparing metadata describing the two fields of view and/or by comparing the appearance of features of field 1200 (e.g., line markings 1206) as they appear in the two images. These techniques are also applicable if the same camera is capturing both images, since scaling and/or perspective may change over time even for a video signal generated using a single camera.

Background advertisements found in advertisement locations 1220, 1222 and 1224, when viewed as part of a video signal, may be blocked by objects or individuals, and these background advertisements may thus be only partially visible. The media guidance application might not generate selectable advertisements for display if that is the case. Alternatively, the media guidance application may cause the selectable advertisements to be displayed within an alternative location, such as by causing selectable advertisement 904 to be displayed instead of selectable advertisement 802 or 1002 whenever background advertisement 602 is only partially (if at all) visible. As a third alternative, the media guidance application may overlay portions of a selectable advertisement or selectable option only onto the visible portion of the background advertisement.

The media guidance application may detect the presence of a background advertisement even if the background advertisement is partially or fully blocked from view by relying on information regarding locations of background advertisements previously received or generated. For example, if a background advertisement is detected in a previous image and a change vector is calculated between the previous and current image, the location of the background advertisement can be determined based on its location in the previous image and the change factor, whether or not the background advertisement is partially or not at all visible in the current image. As another example, if the media guidance application determines a background advertisement's location based on certain features or characteristics present in the received video signal (e.g., information identifying advertisement locations 1220 position relative to the position of line markings 1202) or based on the position of a background advertisement previously detected at a time when the video signal was similar to the current video signal, the media guidance application may determine the location of the background advertisement within a current image of the video signal even if the background advertisement is partially or fully blocked from view.

Alternatively or in combination, the media guidance application may perform any of the image analysis discussed in this application on a version of the video signal that is low-pass filtered in the time domain. This may involve determining which areas of images of the video signal correspond to each other. Then, changes in these corresponding areas may be low-pass filtered across time in order to discount or eliminate temporary changes to this area of the images (e.g., a player walking across a court) while preserving static elements of field 1200 (e.g., advertisement location 1220).

Instead of analyzing images of the video signal in order to identify characteristics (e.g., the presence of line markers 1206, 1202 and/or 1204), and directly using these characteristics to detect background advertisements, the media guidance application can also use these characteristics to map the field of view captured by a current images of the video signal onto an area of field 1200. Once an area of field 1200 has been determined, information discussed above regarding potential or actual advertisements location (e.g., information indicating potential or actual advertisement locations within field 1200) can be retrieved and used to detect a background advertisement within the current image of the video signal.

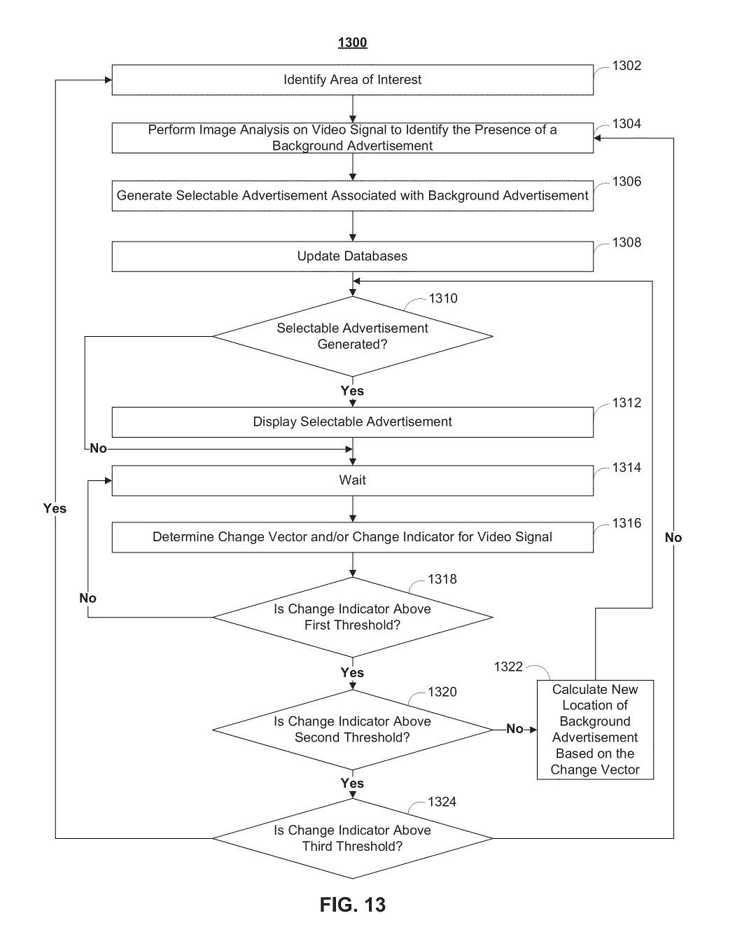

Process 1300 of FIG. 13 illustrates in greater detail the processing that may be involved in performing steps 1104-1108 of FIG. 11.

At step 1302, at least one area of interest is identified in the current image of the received video signal. As discussed above, an area of interest is a location within an image of the received video signal that may potentially or likely include a background advertisement. Any advertisement location identifying information or technique described above as relevant to identifying the actual or potential advertisement locations may also be used to identify an area of interest. For example, in one embodiment a change vector may be used to directly determine a new location of background advertisement, while in another embodiment the change vector is only used to identify the new location as an area of interest.

At step 1304, the media guidance application performs image analysis on the area of interest to determine if a background advertisement is present. The area of interest may thus be used to limit the area of the screen that needs to be searched in order to determine if a background advertisement is present. Alternatively, the media guidance application may perform image recognition on the entire current image of the video signal. This may occur either every time process 1300 is performed or only if no area of interest is identified in step 1302.

As part of the image analysis, the media guidance application may correlate the area of interest with either a general or advertisement-specific pattern or image, may search the area of interest for specific signal patterns (e.g., a rapid change in color along a straight line may indicate the border between a background advertisement and the panel it is attached to) or may perform OCR on the area of interest (e.g., perform OCR on the area of interest and match the results against a database of advertisement subject matter and/or sponsors). The patterns, images, and database of advertisement subject matter and/or sponsors may be received from media content source 416 together with the video signal, may be retrieved from media content source 416 in response to process 1300 being performed, may be received from media guidance data source 418 as media guidance data, may be received from media guidance data source 418 as part of the software that makes up the media guidance application and/or may be stored at another server. The patterns, images and database may be specific to the particular video signal (e.g., received as media guidance data for the program represented by the video signal), may be specific to the type of event (e.g., a specific pattern for use with basketball games), or may be generally applicable to all background advertisements.

Additionally, information identifying the video signal or some aspect of it that is received from media content source 416 or media guidance data source 418 may be used to retrieve the patterns, images and/or database of advertisement subject matter and/or sponsors. For example, media guidance data may indicate a venue (e.g., field 1200) associated with the received video signal, and the media guidance application may retrieve the patterns images and/or database of advertisement subject matter and/or sponsors from a server associated with the venue. Image analysis may also involve performing a more general search based on information extracted from the area of interest. For example, if performing OCR results in text, an Internet search may be performed using this text as a search string. If the Internet search has any results that may be associated with a background advertisement, the media guidance application may determine that a background advertisement is in fact present. Alternatively, the media guidance application may determine that a background advertisement is present due to the mere conclusion that the area of interest is likely to contain text (e.g., if there is a greater than 75% chance that the area of interest includes a word of at least four letters, the media guidance application concludes that a background is present).

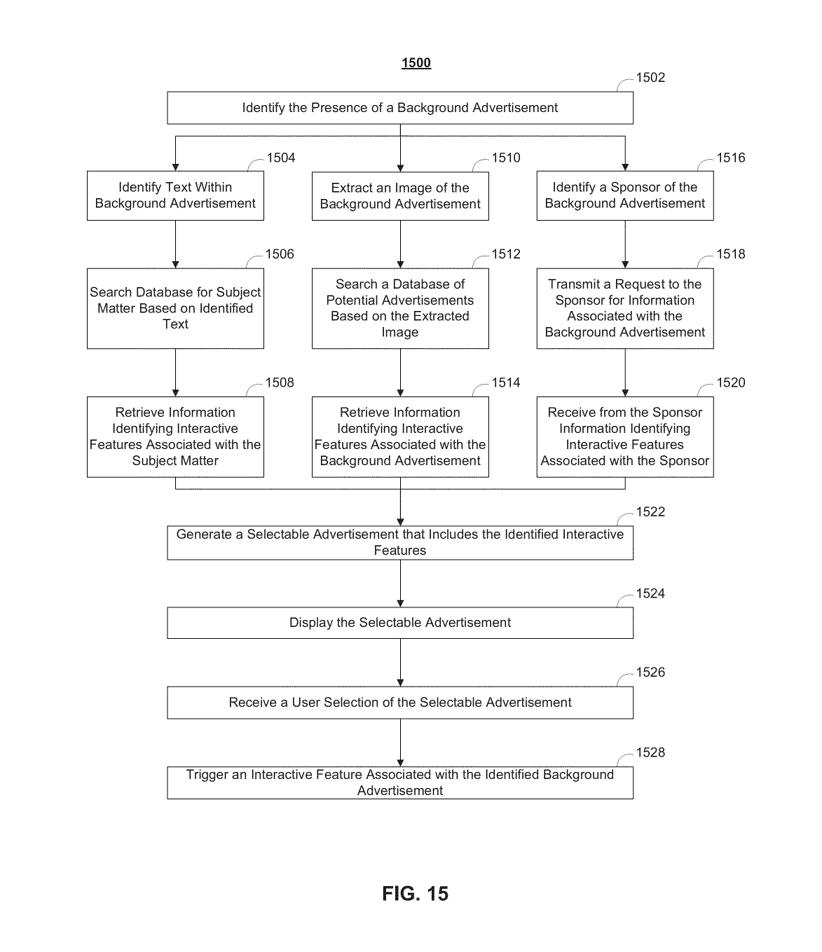

Processes for retrieving or receiving information identifying interactive features associated with a background advertisement, such as the processing discussed below in reference to FIG. 15, may also be used to detect the presence of a background advertisement.

If the media guidance application does not detect a background advertisement, the media guidance application may (potentially after a wait similar to the wait performed at step 1314) return to step 1302 (not shown). Alternatively, the media guidance application may update databases, similar to the update performed at step 1308, based on the lack of a background advertisement in the identified area of interest.

As was already mentioned in reference to step 1104 of FIG. 11 and will be discussed in further detail below in reference to FIG. 15, the media guidance application may also identify a subject matter or sponsor of the background advertisement at step 1304 or may do so in a separate additional step.

At step 1306, the media guidance application generates a selectable advertisement or selectable options associated with the background advertisement. This step corresponds to step 1106 of FIG. 11 and step 1522 of FIG. 15.

At step 1308, the media guidance application updates one or more databases. This may involve generating or updating data structures associated with the identified area of interest and/or the background advertisement. For example, the advertisement location identifying information discussed above in reference to FIG. 12 may be updated to reflect information that has or has not resulted in the successful generation of a selectable advertisement. Updating the advertisement location identifying information may involve storing additional advertisement location identifying information (e.g., a new advertisement location relative to line markings 1202) or flagging unsuccessful advertisement location identifying information (e.g., if no selectable advertisement was generated for a background advertisement in advertisement locations 1224, advertisement locations 1224 may be processed last or not at all in future iterations). As another example, once a background advertisement has been located, its image may be stored in a database of known background advertisements, and the area of interest may be first correlated against these known background advertisements before other detection approaches are attempted. Additionally, a data structure as discussed in reference to step 1306 of FIG. 13 may be generated in order to bypass some of the processing required to generate a selectable advertisement (e.g., identifying interactive features associated with the background advertisement).

At step 1310, the media guidance application checks whether a selectable advertisement was generated in step 1306. This may involve checking a field within one of the data structures updated at step 1308, checking whether a link to a data structure for a selectable advertisement is valid and/or attempting to retrieve a data structure for the selectable advertisement.

If the media guidance application determines at step 1310 that a selectable advertisement was generated, the media guidance application causes the selectable advertisement to be displayed at step 1312. Step 1312 thus corresponds to step 1108 of FIG. 11. If the media guidance application determines at step 1310 that no selectable advertisement was generated, the media guidance application proceeds to step 1314.

At step 1310, the media guidance application waits. The media guidance application may wait for a set period of time. For example, the media guidance application may receive periodic hardware interrupts triggered by processing circuitry 306 or another component within user equipment device 300. These interrupts may cause processing circuitry to wake up and either to directly continue with executing process 1300 or to first check whether sufficient time has passed. Alternatively, the media guidance application may first check whether an alternative condition has been met before proceeding. The timing of the interruptions may also be software driven and/or contingent upon other processing being complete. For example, continuing with process 1300 (or at least a check to determine if enough time has passed) may occur whenever media guidance application finishes executing a particular process, has a lull in its processing timeline, and/or receives a request to continue processing from another component or device.

At step 1316, after waking up, the media guidance application may calculate a change vector. As discussed above in reference to FIG. 11, this may involve correlating and/or comparing a previous image (or portion thereof) of the video signal with a current image (or portion thereof) of the video signal. A change vector may include both a magnitude (e.g., a single value indicating how far the video signal has shifted over time) and a direction (e.g., in which direction the image signal has advanced). In addition, the media guidance application may maintain a separate flag that indicates that it was unable to calculate a change vector (e.g., because the image completely changed) and/or a confidence value indicating how likely it is that the change vector is correct. Both the flag and the confidence value may be based on the maximum correlation value determined (i.e., the highest level of overlap the media guidance application was able to find between the current and previous images), and the confidence value may be additionally determined based on a look-up table. Alternatively or additionally, either the flag or the confidence value may take into account the magnitude and/or direction of the change vector. Any one or more of the change vector, the flag and the confidence value may be referred to as change indicators.

The threshold for determining if the flag is to be set and/or the look-up table used to calculate the confidence value may be calibrated based on past measurements. For example, in addition to calculating the change vector, the media guidance application may occasionally or every time execute step 1304 in order to confirm that the background advertisement really is located at an expected location (e.g., whether the new location of the background advertisement is the sum of the old location and the change vector). Based on this determination, the media guidance application may change the threshold and/or update the look-up table. For example, if previous calculations prove to have been accurate and the background advertisement really is located at the expected new location, the media guidance application may decrease threshold and/or update the look-up table to reflect higher confidence values.

At step 1318, the media guidance application may determine whether a change indicator is below a first threshold. This check may be performed if the selectable advertisement is displayed over the background advertisement. For example, if the magnitude of the change vector is below the first threshold, the media guidance application may determine that the location of the selectable advertisement is sufficiently corresponding to the location of the background advertisement to indicate that the previous location of the selectable advertisement is still appropriate for the current image (e.g., the selectable advertisement is still properly displayed over the background advertisement). If the magnitude of the change vector is below the first threshold, the media guidance application may return to step 1314 and continue to wait.

If the change indicator is above the first threshold this may signify that the display of the selectable advertisement needs to be updated, and the media guidance application may proceed to step 1320. At this step, the media guidance application determines whether the change indicator is above a second threshold. For example, the media guidance application may check whether the flag is set (e.g., whether the media guidance application was even able to calculate a change vector) and/or whether the confidence value and/or the magnitude of the change vector is above another threshold (e.g., whether the change vector can be trusted).

If the media guidance application determines that the change indicator is not above the second threshold, the media guidance application may, at step 1322, calculate a new location of the background advertisement and/or a new location in which to display the selectable advertisement. Calculating these new locations may involve adding the change vector to the previous location of the background advertisement and/or selectable advertisement. Accordingly, if the media guidance application determines that the change vector has been successfully calculated, can be trusted and/or that no additional image processing is required to confirm the location of background advertisement, the media guidance application may update the location of the background advertisement and/or the selectable advertisement without having to perform additional image processing. Alternatively, if no background advertisement was detected in the first place and/or no selectable advertisement was generated, the media guidance application may simply return to step 1314 and continue to wait.

If the media guidance application determines that the condition of step 1320 is not met, the media guidance application may proceed to step 1324 and determine whether the change indicator is above a second threshold. For example, the media guidance application may determine whether the confidence value is above a particular threshold, thereby determining to what extent the video signal has advanced. As another example, a large enough magnitude of the change vector or a low enough confidence value may indicate that the previously identified area of interest is no longer relevant. This may be the case if the previously identified area of interest is no longer visible within the current image of the video signal. This may be the case because the video signal has changed to a completely different camera (e.g., the video signal has switched from camera 1216 to camera 1208), has switched to a different background altogether (e.g., the video signal has switched from field 1200 to a commentator interview), and/or has switched to a completely different segment (e.g., the video signal has switched to a commercial break or a different program). If the condition of step 1324 is met, the media guidance application may proceed to step 1302 and identify a new area of interest.

If the condition of step 1324 has not been met, the media guidance application may determine that, while the change vector is not sufficiently reliable to merit updating the location of the background advertisement without additional image processing, the previously identified area of interest may still be utilized. For example, the media guidance application may proceed to perform step 1304 on the same area of interest previously identified in order to determine if a background advertisement is still present within. Alternatively, the media guidance application may shift the old area of interest or the location of the previously detected background advertisement according to the change vector, and use the result as a new area of interest in which to detect a background advertisement. Accordingly, even if the video signal has changed sufficiently to merit further processing, previously determined results may be leveraged to detect a new location of a background advertisement.

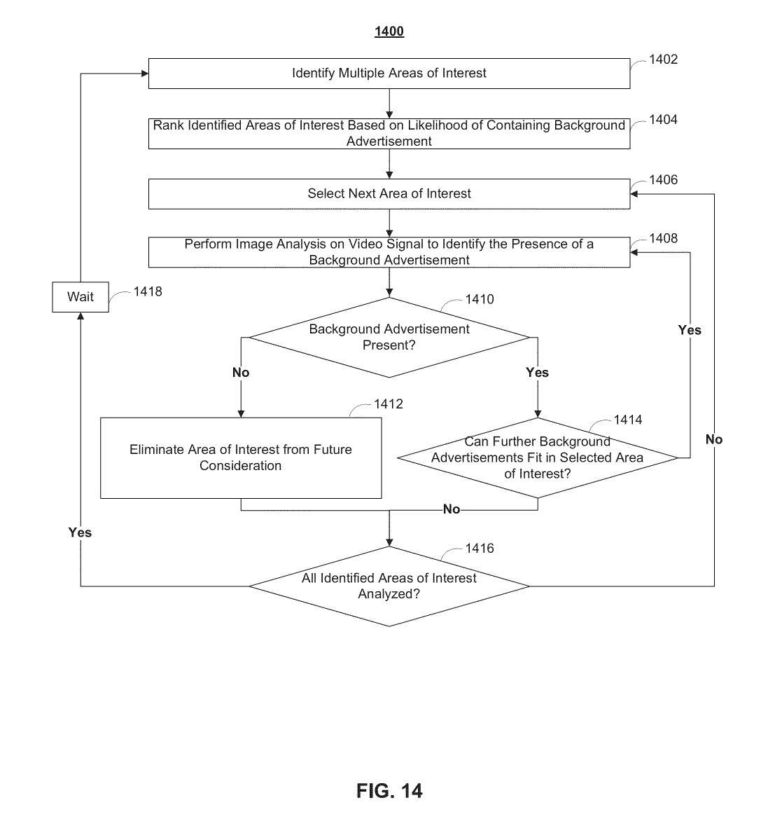

Process 1400 of FIG. 14 illustrates in greater detail the processing that may be involved in performing steps 1302-1304 of FIG. 13. Specifically, while the area of interest identified in step 1302 of FIG. 13 has been discussed as a single area identified within an image of a received video signal, this need not be the case. Instead, the media guidance application may identify at step 1402 of FIG. 14 multiple such areas using any of the techniques discussed in reference to step 1302 of FIG. 13 and/or by dividing the entire image of the video signal into multiple areas.

At step 1404, the media guidance application may rank these different areas of interest. This may involve ranking the different areas based on how likely it is that a background advertisement is located in each area. The likelihood may, in turn, be determined based on the information used to identify the corresponding area of interest in the first place. For example, the advertisement location identifying information discussed in reference to FIG. 12 may be associated with information identifying the likelihood of a background advertisement being present. For example, the advertisement location identifying information may indicate that it is more likely for a background advertisement to be found above line markings 1202 (e.g., within one of advertisement locations 1220) than it is for a background advertisement to be found to the right of line markings 1202 (e.g., within one of advertisement locations 1224). This likelihood may be dictated by general statistics (e.g., more basketball stadiums have advertisements at advertisement locations 1220 than at advertisement location 1224), by the probability of error (e.g., while both advertisement locations 1220 and advertisement locations 1224 are equally likely to include advertisements, the media guidance application is more likely to be unable to identify the sponsor and/or subject matter of an advertisement in advertisement locations 1224, since those advertisements are more likely to be distorted due to glare), by the level of importance (e.g., while both advertisement locations 1220 and advertisement locations 1224 are equally likely to include advertisements, sponsors pay more to display their advertisements within advertisement locations 1220), and/or by past success (e.g., a background advertisement has been previously located within advertisement locations 1220). Ranking the areas of interest may be useful in prioritizing which areas of the received video signal to process if there are only limited processing resources. Steps 1402 and 1404 may also be combined. For example, step 1402 may entail identifying areas of interest in an order that is based on the likelihood of a background advertisement being present in each, thereby also performing some or all of the ranking otherwise done in step 1404.

At step 1406, the media guidance application selects the next area of interest for processing. This may be the highest ranked or the next highest ranked area of interest.

Alternatively, the media guidance application might skip step 1404. Instead, the media guidance application may maintain the areas of interest in any order (e.g., in the order in which they are identified and/or based on their location within an image of the video signal) or in no order at all (e.g., by processing each area of interest within an image as it is identified instead of first identifying multiple areas of interest). If that is the case, step 1406 may involve selecting the next area of interest, selecting a random area of interest and/or processing the only currently identified area of interest.

At step 1408, the media guidance application performs image recognition on the selected area of interest. This step may correspond to step 1304 of FIG. 13.

At step 1410, the media guidance application determines whether a background advertisement is located within the selected area of interest. This may involve processing similar to the processing discussed above in reference to step 1304 of FIG. 13.

If the media guidance application determines at step 1410 that a background advertisement is located in the selected area of interest, the media guidance application may, at step 1414, determine whether additional background advertisements can fit within the selected area of interest. For example, as illustrated in FIG. 12, three advertisements may be located within advertisement locations 1220. The media guidance application may determine the area taken up by the background advertisement recognized in step 1410 and determine whether an additional background advertisement can fit within the selected area of interest. For example, if the area of interest corresponds to advertisement locations 1220, an additional two background advertisements may be locations within the area even after the first background advertisement has been identified. If that is the case, the media guidance application may return to step 1406 and determine whether additional background advertisements are located within the area of interested selected at step 1406.

If the media guidance application determines at step 1410 that no background advertisement was detected at step 1408, the media guidance application may proceed to step 1412 and eliminate or downgrade the currently selected area of interest. For example, if the media guidance application was unable detect a background advertisement within advertisement locations 1220, it is unlikely that a background advertisement will be detected within advertisement locations 1220 in future iterations. Accordingly, the media guidance application may eliminate or degrade (e.g., move down in likelihood and/or potential ranking) any area of interest and/or advertisement location identifying information corresponding to advertisement locations 1220. Additionally, the media guidance application may eliminate or degrade related areas of interest. For example, if no background advertisement is detected by the media guidance application after analyzing advertisement locations 1222, the media guidance application may eliminate or degrade both advertisement locations 1222 and advertisement locations 1224 as areas of interest. After all, due to the symmetry of field 1200, if advertisement locations 1222 do not include an actual advertisement, it is highly likely that advertisement locations 1224 do not include an actual advertisement either. This association between advertisement locations 1222 and 1224 may be due to general information associated with the present type of event, due to past processing performed by the media guidance application and/or due to information received from media guidance source 416 and/or media guidance data source 418. The processing performed at step 1412 may thus impact the current ranking of the identified areas of interest.

At step 1416, the media guidance application may determine whether all or all still relevant (e.g., some areas of interest may be eliminated as part of step 1412) areas of interest identified in step 1402 have been analyzed. If all identified areas of interest have been analyzed, the media guidance application may proceed to step 1418 and wait. Step 1418 may correspond to step 1314 of FIG. 13 and allow for enough time to pass for the received video signal to advance sufficient for new areas of interest and/or background advertisement to be potentially visible. Similar to step 1314, process 1400 may continue to wait (e.g., by returning to step 1416) until the magnitude of a change vector, a fag related to generation of the change vector and/or a confidence interval meet a predestined criteria.

Alternatively, if the media guidance application determines at step 1416 that further identified areas of interest are available for processing, the media guidance application may proceed to step 1406 and begin processing the next highest ranked area of interest.

Process 1500 of FIG. 15 illustrates in greater detail the processing that may be involved in performing steps 1302-1312 of FIG. 13. Additionally, steps 1524-1528 of FIG. 15 generally correspond to steps 1308-1312 of FIG. 12.

At step 1502, the media guidance application detects that a background advertisement is present in an image of the received video signal. This may be accomplished through any of the techniques discussed above. Alternatively, the media guidance application may identify an area of interest at step 1502 and perform the remainder of process 1500 using the identified area of interest. In at least one embodiment, the distinction between an area of interest and a detected background advertisement is the degree of confidence the media guidance application has in its detection of the background advertisement. For example, the media guidance application may determine whether an area of an image of the video signal is an area of interest that requires further image processing to determine whether a background advertisement is actually present or whether the particular area can be considered a background advertisement. This may involve performing calculations similar to those discussed above in reference to step 1404 of FIG. 14.

The media guidance may use one or more sets of steps 1504-1508, steps 1510-1514 and steps 1516-1520 to identify interactive features associated with the background advertisement. The media guidance application may automatically use certain sets of steps, may determine whether to use a set of steps based on the information available (e.g., whether the video signal is received with metadata indicating potential background advertisements) and/or may determine which set of steps to use based how confident the media guidance application is that a background advertisement has been detected.

At step 1504, the media guidance application may perform OCR on the background advertisement. For example, if OCR is performed on advertisement 700, the result may be text identifying subject matter 702 or logo 7g06. At step 1506, the media guidance application may use this text as a search string to search a database of potential subject matter, such as a database of different companies, media assets or products, to identify the subject matter of the background advertisement. As a first example, the media guidance application may search the media guidance data to identify content associated with the background advertisement. As a second example, the media guidance application may search data received with the video signal that indicates background advertisements found in the video signal. As a third example, the media guidance application may perform an Internet search for websites associated with the identified text.

At step 1508, the media guidance application may retrieve information identifying interactive features associated with the subject matter identified at step 1506. The media guidance application may retrieve such information from the database searched at step 1506. This information may include a link to a website (e.g., a search result from an Internet search performed at step 1506) or other source of information (e.g., the media guidance application may search media guidance data received from media guidance data source 418 for a program whose title matches the identified subject matter) associated with the identified subject matter, in which case one interactive feature may be selectable option 860 for accessing the additional information. Similarly, the information may indicate a group or tag that is available within an online social network, in which case one interactive feature, such as selectable option 858, may be able to modify the user's online profile in order to join the group or in order to include the tag. The information may also indicate content available from media content source 416 or an alternative content source. Selectable options 856 and 862 may thus become linked to a future broadcast of a program that is advertised in the background advertisement. Alternatively, the information identifying interactive features may include flags indicating which functions are available for the subject matter of the background advertisement. For example, if the identified subject matter is a product, the information may indicate that recordation of content associated with the background advertisement is not an available interactive feature. Similarly, if the identified subject matter is a product, the information may indicate that ordering the product from a local store is an available interactive feature.

Instead of, or in combination with, performing a text-based search, the media guidance application may also identify interactive features associated with the background advertisement using an image based search. At step 1510, the media guidance application extracts an image of the background advertisement for use in the search. This might be an image of the entire background advertisement or only a portion thereof (e.g., a pattern or other characteristic embedded within the background advertisement).

At step 1512, the media guidance application may search a database of images-based on this extracted image. The search may involve identifying images visually similar to the extracted image. The database may consist of potential background advertisements, images associated with potential subject matter (e.g., movie posters to determine if the background advertisement is for an upcoming movie), general patterns (e.g., patterns such as border 704 that may be linked to background advertisements, interactive features and/or potential subject matter) or a general database of images (e.g., performing an image based Internet search). This database may be related to specific content that includes the video signal (e.g., media content source 416 may maintain a database of all background advertisements known to be present in particular content), a sponsor of the background advertisement (e.g., owner of field 1200 may maintain a remote database with all advertisements present at field 1200) or may be applicable to any content (e.g., sponsors may contribute images of their advertisements to a centralized database).

At step 1514, the media guidance application retrieves information identifying interactive features associated with the background advertisement. The processing involved in retrieving the information may mirror the processing performed at step 1508.

The media guidance application may also identify interactive features associated with a background advertisement by first, at step 1516, identifying a sponsor of the background advertisement. This might involve analyzing the background using any of the techniques discussed above in reference to steps 1504-1508 or steps 1510-1514. Alternatively, the media guidance application may also be able to retrieve information identifying the sponsor from metadata received with the video signal from media content source 416, from media guidance data received from media guidance data source 418 for the content that includes the video signal (e.g., the media guidance data may identify an owner of field 1200), from information received from any other source or by performing a search using information received from any of those sources (e.g., the media guidance data may identify field 1200, while an Internet search based on the identify of field 1200 may lead to information identifying the owner of field 1200).

At step 1518, the media guidance application may transmit a request to a server associated with the sponsor identified at step 1518. The server may be identified based on the information identifying the sponsor, either directly (e.g., the received metadata includes an IP address of the server) or via an additional search (e.g., information identifying the sponsor may be utilized to search for a website associated with the sponsor). The request may identify the content that include the video signal (e.g., a particular basketball game or movie), a time stamp regarding the time relative to the start of the video signal when the background advertisement was detected, and/or location information identifying where the background advertisement was detected (e.g., advertisement locations 1220).

In response to the transmitted request, the media guidance application may, at step 1520, receive information identifying interactive features associated with the background advertisement. This information may be similar to the information retrieved in either step 1508 or step 1514. Additionally, the media guidance application may receive from the server associated with the sponsor an image for use in the selectable advertisement. For example, the background advertisement might only advertise the sponsor, whereas the information identifying interactive features and images received from the sponsor's server may result in the generation of a selectable advertisement for a specific product selected by the sponsor. Accordingly, this mechanism may be used by the sponsor to target selectable advertisements and, to facilitate this, the media guidance application may include information from the user profile in the request it transmits to the sponsor's server at step 1518.

While each set of steps 1504-1508, steps 1510-1514 and steps 1516-1520 has been discussed as identifying interactive information after a background advertisement has already been detected, the media guidance application may also detect the background advertisement by performing one or more sets of steps 1504-1508, steps 1510-1514 and steps 1516-1520. The media guidance application may do so by performing these sets of steps on an area of interest instead of a detected background advertisement. If the execution of any one of sets of steps 1504-1508, steps 1510-1514 and steps 1516-1520 results in the retrieval or receipt of information identifying one or more interactive features, the media guidance application may determine that a background advertisement is present.

At step 1522, the media guidance application generates a selectable advertisement that includes the information identifying interactive features associated with the background advertisement. For example, the media guidance application may generate, populate and/or update the structure as discussed in reference to step 1306 of FIG. 13. The media guidance application may additionally store the information retrieved or received in one or more of step 1508, step 1514 and step 1520 to the same data structure.

At step 1524, the media guidance application causes the selectable advertisement to be displayed. This may involve retrieving the data structure described above in reference to step 1522. The media guidance application may then cause the selectable advertisement to be displayed in the manner discussed above in reference to step 1308 of FIG. 13.

At step 1526, the media guidance application may receive a user selection of the selectable advertisement that was displayed at step 1524. The media guidance application may receive the user selection in the manner discussed above in reference to step 1310 of FIG. 13.

At step 1528, the media guidance application may trigger the identified interactive feature that is associated with the background advertisement by performing a function. The media guidance application may perform the function in the manner discussed above in reference to step 1312 of FIG. 13. The media guidance application may retrieve the data structure generated at step 1522 and utilize information stored therein when performing the function. For example, the data structure may include a pointer to the function to be executed. Alternatively or additionally, the data structure may include data (e.g., URL of website that provide further information, link to media guidance data of an advertisement program to be downloaded or recorded, tag to be added to an online user profile) necessary for the function to be executed, and this data or a link thereto may be passed to the function.

While the processes above have been generally described as a sequence of steps, any of these steps may also be executed simultaneously using a parallel architecture. For example, one processor may continuously or periodically perform image analysis to detect the presence of background advertisements in a received video signal, a second processor may analyze these background advertisements and communicate with one or more servers or databases to identify interactive features and generate selectable advertisements, a third processor may cause the selectable advertisements to be displayed, and/or a fourth processor may continuously or periodically process the received video signal to calculate a change vector. These one or more processors may communicate by writing the results of their processing (e.g., a current change vector, a current location of a detected background advertisement, a flag indicating that a background advertisement has been detected and/or that a selectable advertisement has been generated, a data structure corresponding to a selectable advertisement) to memory, such as a tightly coupled memory of storage 308. Another processor may then retrieve these results for use in its own processing.

It will be apparent to those of ordinary skill in the art that the systems and methods involved in the present application may be embodied in a computer program product that includes a computer usable, non-transitory, and/or readable medium. For example, such a computer usable medium may consist of a read-only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the implementations describe herein. Those skilled in the art will appreciate that aspects of the application can be practiced by other than the described implementations, which are presented for purposes of illustration rather than of limitation, and the aspects are limited only by the claims which follow.

1. A method for generating interactive advertisements, the method comprising:
receiving a video signal;
performing image analysis on the received video signal to identify that a background advertisement is present in the video signal;
identifying an interactive feature associated with the background advertisement;
generating a display of the received video signal;
causing a selectable advertisement to be simultaneously displayed with the video signal, wherein the selectable advertisement is associated with the identified interactive features;
receiving a user selection of the selectable advertisement; and
triggering, in response to the user selection, the interactive feature associated with the background advertisement.

2. The method of claim 1 further comprising:
identifying an area of interest within the received video signal, wherein performing image analysis on the received video signal comprises performing image analysis on the area of interest.

3. The method of claim 2, wherein identifying the area of interest comprises:
receiving information identifying a location the area of interest relative to a location of a feature of the received video signal;
performing image analysis on the received video signal to identify the location of the feature of the received video signal; and
calculating the location of the area of interest based on the location of the feature of the received video signal and the received information.

4. The method of claim 3, wherein the video signal is part of a live broadcast of a sporting event, and wherein the feature of the received video signal comprises a line marking of a field associated with the sporting event.

5. The method of claim 1, wherein causing the selectable advertisement to be displayed comprises:
identifying a location of the background advertisement; and
causing the selectable advertisement to be displayed at the identified location.

6. The method of claim 5 further comprising:
periodically calculating a change vector between a current image of the video signal and a previous image of the video signal;
determining, based on the calculating, whether the video signal has changed less than a threshold; and
if the video signal has changed less than the threshold:
calculating a new location of the background advertisement based on a previous location of the background advertisement and the change vector; and
causing the selectable advertisement to be displayed in the new location.

7. The method of claim 1 further comprising, in response to identifying that the background advertisement is present:
storing information describing a first image of the video signal, wherein the first image comprises the background advertisement;
storing the selectable advertisement, wherein the stored selectable advertisement is associated with the first image;
at a later time, comparing the first image with a current image of the video signal; and
if the current image matches the first image:
retrieving the stored selectable advertisement; and
causing the stored selectable advertisement to be displayed.

8. The method of claim 1, wherein:
performing image analysis comprises:
performing optical character recognition on a current image of the received video signal;
generating a search string using recognized text;
searching a database of media guidance data based on the generated search string; and
identifying content matching the generated search string; and
triggering the interactive feature comprises receiving the identified content.

9. The method of claim 1, wherein:
performing image analysis to identify that the background advertisement is present comprises identifying a sponsor of the background advertisement; and
generating the selectable advertisement comprises:
transmitting a request to a server associated with the sponsor; and
receiving, in response to the request, information identifying interactive features.

10. The method of claim 9, further comprising:
receiving an image from the server associated with the sponsor in response to the request; and
causing the received image to be displayed as part of the displayed selectable advertisement.

11. A system for generating interactive advertisements, the system comprising:
processing circuitry configured to:
receive a video signal;
perform image analysis on the received video signal to identify that a background advertisement is present in the video signal;
identify an interactive feature associated with the background advertisement;
generate a display of the received video signal;
cause a selectable advertisement to be simultaneously displayed with the video signal, wherein the selectable advertisement is associated with the identified interactive features;
receive a user selection of the selectable advertisement; and
trigger, in response to the user selection, the interactive feature associated with the background advertisement.

12. The system of claim 11, wherein the processing circuitry is further configured to:
identify an area of interest within the received video signal, wherein the processing circuitry is configured to perform image analysis on the received video signal by being further configured to perform image analysis on the area of interest.

13. The system of claim 12, wherein the processing circuitry is configured to identify the area of interest by being further configured to:
receive information identifying a location the area of interest relative to a location of a feature of the received video signal;
perform image analysis on the received video signal to identify the location of the feature of the received video signal; and
calculate the location of the area of interest based on the location of the feature of the received video signal and the received information.

14. The system of claim 13, wherein the video signal is part of a live broadcast of a sporting event, and wherein the feature of the received video signal comprises a line marking of a field associated with the sporting event.

15. The system of claim 11, wherein the processing circuitry is configured to cause the selectable advertisement to be displayed by being further configured to:
identify a location of the background advertisement; and
cause the selectable advertisement to be displayed at the identified location.

16. The system of claim 15, wherein the processing circuitry is further configured to:
periodically calculate a change vector between a current image of the video signal and a previous image of the video signal;
determine, based on the calculating, whether the video signal has changed less than a threshold; and
if the video signal has changed less than the threshold:
calculate a new location of the background advertisement based on a previous location of the background advertisement and the change vector; and
cause the selectable advertisement to be displayed in the new location.

17. The system of claim 11, wherein the processing circuitry is further configured to, in response to identifying that the background advertisement is present:
store information describing a first image of the video signal, wherein the first image comprises the background advertisement;
store the selectable advertisement, wherein the stored selectable advertisement is associated with the first image;
at a later time, compare the first image with a current image of the video signal; and
if the current image matches the first image:
retrieve the stored selectable advertisement; and
cause the stored selectable advertisement to be displayed.

18. The system of claim 11, the processing circuitry is configured to:
perform image analysis by being further configured to:
perform optical character recognition on a current image of the received video signal;
generate a search string using recognized text;
search a database of media guidance data based on the generated search string; and
identify content matching the generated search string; and
trigger the interactive feature by being further configured to receive the identified content.

19. The system of claim 11, wherein the processing circuitry is configured to:
perform image analysis to identify the that the background advertisement is present by being further configured to identify a sponsor of the background advertisement; and
generate the selectable advertisement by being further configured to:
transmit a request to a server associated with the sponsor; and
receive, in response to the request, information identifying interactive features.

20. The system of claim 19, wherein the processing circuitry is further configured to:
receive an image from the server associated with the sponsor in response to the request; and
cause the received image to be displayed as part of the displayed selectable advertisement.

21-40. (canceled)
